(19) United States
(12) Patent Application Publication
(10) Pub. No.: US 2009/0202175 A1
(43) Pub. Date: Aug. 13, 2009

(54) Methods And Apparatus For Object Detection Within An Image

(76) Inventors: Michael Guerzhoy, North York (CA); Hui Zhou, Toronto (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/029,603

(22) Filed: Feb. 12, 2008

(51) Int. Cl. G06K 9/36

(52) U.S. Cl. 382/289

(57) ABSTRACT

A method and device for estimating an orientation of an object, such as a face, within an image. One example method includes estimating an orientation of the image. The image is then analyzed using first and second candidate object orientations to generate respective first and second confidence values. The first candidate object orientation is equal to the estimated image orientation and the second candidate object orientation differs from the first candidate object orientation by a first predetermined angle, such as 180°. The method further includes estimating the orientation of the object based at least in part on the first and second confidence values.

### BACKGROUND

1. The Field of the Invention

The present invention relates generally to detection of objects, such as faces, within images. More specifically, embodiments of the present invention relate to methods and systems using image orientation analysis to assist in the detection of an object, such as a face, within the image.

2. The Relevant Technology

Various image processing applications involve detection of a particular object, such as a face, present within an image. Furthermore, it is often necessary to detect the object's orientation. Applications in which detection of an object's orientation is useful include, for example, object tracking; image enhancement techniques such as object isolation and background replacement; eye tracking and others.

One problem with many conventional image processing applications and algorithms is that they are often very computationally intensive. As such, such applications might require the use of relatively expensive computational resources to execute efficiently, which can be prohibitively expensive. In addition, such applications can be very time-consuming to execute—a problem which is exacerbated depending on the computing resources used. Thus, an image processing application/algorithm that can be implemented and executed in a more efficient manner, and in a manner that requires less computational resources, can greatly increase the application's practical value.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments of the present invention provide methods and apparatus for estimating an orientation of an object in an image. Moreover, disclosed methodologies are more computationally efficient and thus require less processing time and/or processing resources. In example embodiments, a reduction of processing time may be achieved by first estimating an orientation of an image in which the object appears. Because an image's orientation can often be estimated faster than objects can be detected in the image, and because it is easier to detect an object whose orientation is known, time can be saved by first estimating image orientation to eliminate unlikely object orientations. For example, certain disclosed embodiments pertain to a method of estimating an orientation of an object, such as a face. Using one exemplary approach, an image is analyzed using first and second candidate object orientations to generate respective first and second confidence values. The first candidate object orientation may equal an estimated image orientation and the second candidate object orientation may differ from the first candidate object orientation by a first predetermined angle, such as 180°. Estimating the orientation of the object may then be performed based at least in part on the first and second confidence values.

Another embodiment of the invention relates to a device for estimating an object's orientation in an image. The device may include an object detecting module adapted to detect the object and a processor adapted to perform various functions. For example, the processor may be adapted to first estimate an orientation of the image. The processor may also be adapted to then analyze the image using first and second candidate object orientations to generate respective first and second confidence values. The first candidate object orientation may be equal to the estimated image orientation and the second candidate object orientation may differ from the first candidate object orientation by a first predetermined angle, such as 180°. Finally, the processor may be adapted to estimate the orientation of the object based at least in part on the first and second confidence values.

Hence, at least one advantage of disclosed embodiments is the ability to detect object orientation within an image, such as a face, in a manner that is computationally efficient. One benefit of the approach is the ability to detect object orientation in a faster time. Further, the optimized methodology can be efficiently executed without the need for expensive processing equipment or devices.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features will be set forth in the description which follows, and in part will be obvious from the description, or may be learned by the practice of the teachings herein. Features of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an exemplary image containing a face whose orientation is unknown;

FIG. 2 illustrates a flow diagram describing one example of a method of estimating an object's orientation in an image; and

FIG. 3 illustrates an exemplary imaging device for receiving an image and estimating an object's orientation in the image.

### DETAILED DESCRIPTION

In the following detailed description of various embodiments of the invention, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

In the following description, an example embodiment of a method and apparatus for object orientation detection is presented. In the example embodiment, a reduction of processing time may be achieved by first estimating an orientation of an image in which the object appears. An exemplary method and apparatus for estimation of image orientation is described in U.S. patent application Ser. No. 11/850,383, titled “Method and System for Automatically Determining the Orientation of a Digital Image” and filed on Sep. 5, 2007, which is incorporated herein by reference. The orientation of an object in an image is often related to the image orientation, and frequently is the same as the image orientation. Because an image's orientation can often be estimated faster than objects can be detected in the image, and because it is easier to detect an object whose orientation is known, time can be saved by first estimating image orientation to eliminate unlikely object orientations.

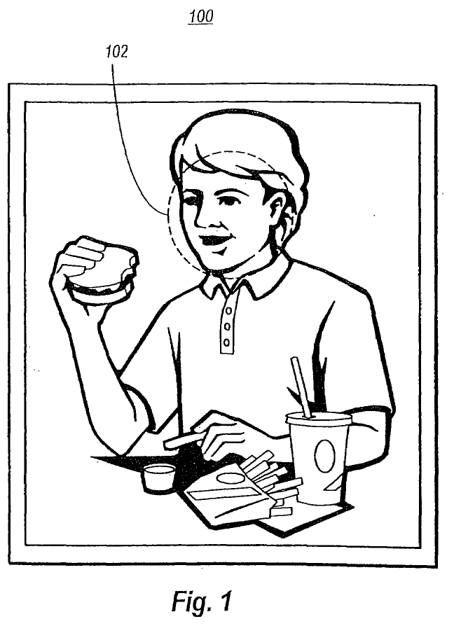

For example, FIG. 1 shows an exemplary image 100 in which an object whose orientation is to be detected appears. The object may be, for example, a subject's face 102. Although a face is used as the object for purposes of discussion, the object may be something other than a face. Thus the exemplary embodiment discussed herein may apply to any image processing application in which knowledge of an object's orientation can help with detecting the object. Examples of objects which can be detected more easily if their orientation is known, and whose orientation can be guessed by detecting the image orientation, are trees, cars, pedestrians, buildings, etc.

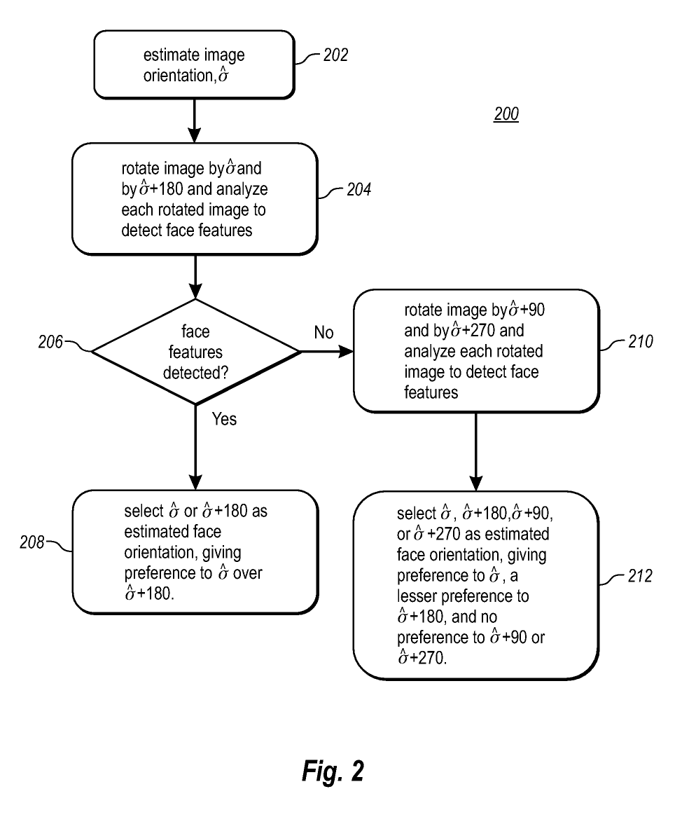

FIG. 2 shows an exemplary method 200 of estimating an orientation of an object, such as face 102, in an image. First, an orientation of the image is estimated (stage 202) to generate an estimated angle, \hat{σ}. For convenience of description, σ, the angle estimated by \hat{σ}, may represent a negative rotation offset, meaning image 102 must be rotated clockwise by σ to be in its proper orientation. (Alternatively, σ may represent a positive rotation offset, in which case a counterclockwise rotation by σ would be required to properly orient the image. Image orientation may be estimated using any sufficiently fast, suitable algorithm including, for example, those described in U.S. patent application Ser. No. 11/850,383, referenced above.

Next, image 102 may be rotated by the estimated image orientation angle, \hat{σ}, and by \hat{σ}+180° and an analysis may be performed to detect patterns representative of faces in each rotated image (stage 204). The angle, \hat{σ}, may be evaluated as candidate object orientation before evaluating other angles because object orientation is frequently the same as the image orientation. The angle \hat{σ}+180° may also be evaluated as an initial candidate because object orientation may frequently be the opposite of an image orientation estimate. In other words, a most likely offset error when estimating image orientation may be 180°.

Analysis of the rotated images may be performed by a customized pattern recognition algorithm. By way of example, image rotation may be performed on the image and each rotated image may be passed to the pattern recognition algorithm for evaluation. Alternatively, image rotation may be performed constructively by the pattern recognition algorithm to preserve memory and processing resources, among other things. For example, instead of allocating memory for two rotated images, memory may be allocated only for the original image with rotation being performed constructively by the pattern recognition algorithm.

Moreover, the pattern recognition algorithm applied at this stage may be configured to execute faster and with less accuracy relative to one applied at a face detection stage, i.e., after face orientation has been estimated. For example, at a face orientation detection stage, reliable face detection and precise face location information may not be necessary. An exemplary pattern recognition algorithm for detecting faces is described in U.S. patent application Ser. No. 11/556,082, titled “Method and Apparatus for Detecting Faces in Digital Images” and filed Nov. 2, 2006, which is incorporated herein by reference. In this exemplary algorithm, an image is divided into various segments or sub-windows and a search for faces is performed in each sub-window using classifiers. A set of cascading phases are applied to detect whether the sub-window includes a face using the following classifiers: a skin-color-based classifier, an edge magnitude-based classifier and a Gentle AdaBoost-based classifier, which may use sophisticated pattern recognition based on sets of training images. Other appropriate classifiers may also be used, instead of or in addition to those listed, in detecting other objects. A first phase is computationally fast, or “cheap”, and the processing requirements of each subsequent phase may increase. If, at any phase, it is determined that a sub-window likely does not represent a face, analysis of the sub-window may terminate so that analysis of a next sub-window may commence. A sub-window may be determined to include a face only when it passes each of the series of classifiers applied. Thus, in stage 204, a first phase of the sub-window searching algorithm may be applied using relatively large sub-window sizes to increase speed. A smaller sub-window size may be used to increase detection accuracy in subsequent phases.

If an object is detected in a sub-window of either rotated image (stage 206), one of the two candidate object orientations (\hat{σ} or \hat{σ}+180°) may then be selected as the estimated face orientation (stage 208). In making the selection, a preference may be given to the orientation that is consistent with the estimated image orientation, \hat{σ}, in light of the fact that objects in an image, such as faces, frequently have the same orientation as the image. However, this may not always be the case. Moreover, an estimated image orientation, \hat{σ}, may be incorrect. Therefore, a preference level may normally be set to a small value and adjustments may optionally be made, dynamically or at an initial time, to compensate for various circumstances, such as a confidence statistic or an expected degree of error associated with the image orientation estimate.

The selection of one candidate object orientation over another may be made based on confidence values derived from a face detection algorithm. A confidence value associated with each candidate orientation may initially be set to zero and may be incremented each time an object is detected. Alternatively, a confidence value may correspond to a number of sub-windows in which at least one object is detected. The confidence value corresponding to the estimated image orientation, \hat{σ}, may be given preference by adding a constant, C, to its confidence value.

If no objects are detected at stage 206, the method may proceed to search for objects in other candidate orientations of the image such as \hat{σ}+90° and \hat{σ}+270° orientations (stage 210). Confidence values may be derived for each of these candidate orientations in the same or a similar fashion described above with reference to stage 208. Confidence values for each of the four candidate orientations, \hat{σ}, \hat{σ}+180°, \hat{σ}+90°, and \hat{σ}+270°, may then be compared to select an orientation as the estimated face orientation (stage 212). A preference may be given to the orientations, \hat{σ} and \hat{σ}+180°, with a lesser preference to \hat{σ}+180°, reflecting a likelihood that objects, such as faces, may typically be oriented consistent with the image orientation estimate and that an offset error may likely be 180°. Thus a constant C1 may be added to the confidence value corresponding to \hat{σ} and a constant C2 may be added to the confidence value corresponding to \hat{σ}+180°, where C1>C2. Furthermore, the preference levels given at stage 212 may both be greater than the preference level given at stage 208. Thus, the constants C1 and C2 may each be greater than the constant C. Alternatively, no preference may be given to the first two candidate orientations, \hat{σ} and \hat{σ}+180°, and, because no objects were detected in either of the first two candidate orientations, a comparison may be made only between the latter candidate orientations, \hat{σ}+90 and \hat{σ}+270°.

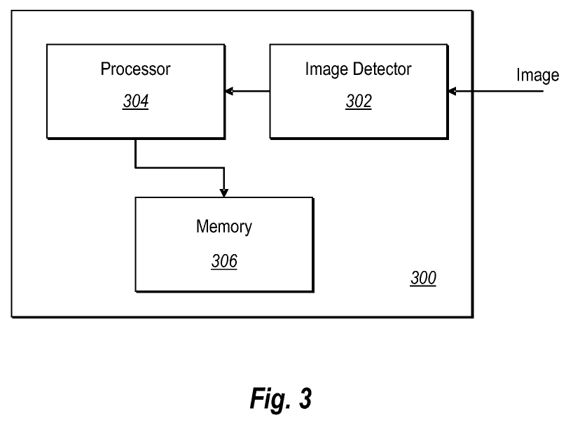

FIG. 3 illustrates an example apparatus for implementing the method of FIG. 2. Imaging device 300 may be a video or single-frame camera, a scanner, or any other image processing device and may include an image detector 302 (e.g., a scanner, a charge-coupled device (CCD), a complimentary-metal-oxide-silicon (CMOS) device, etc.), a processor 304, and a memory module 306. Imaging device 400 may receive images having an unknown orientation via image detector 302 and may estimate an orientation of objects, such as faces, in the received images. Processor 304 may control image detector 302 to receive an image and may implement the method discussed above in connection with FIG. 2 to estimate an orientation of an object in the received image. The image and/or estimated orientation information may be sent to a display for viewing and/or memory module 306 for storage or further processing.

Embodiments herein may comprise a special purpose or general-purpose computer including various computer hardware implementations. Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of estimating an orientation of an object in an image, the method comprising:
estimating an orientation of the image;
analyzing the image using first and second candidate object orientations to generate respective first and second confidence values; and
estimating the orientation of the object based at least in part on the first and second confidence values,
wherein the first candidate object orientation is equal to the estimated image orientation and the second candidate object orientation differs from the first candidate object orientation by a first predetermined angle.

2. The method of claim 1, wherein the first predetermined angle is approximately 180 degrees.

3. The method of claim 1, wherein estimating the orientation of the image includes analyzing an edge direction histogram of the image.

4. The method of claim 1, wherein analyzing the image using the first and second candidate object orientations includes:
rotating the image by a first angle corresponding to the first candidate object orientation;
searching for the object in the image rotated by the first angle to generate a first set of search results;
rotating the image by a second angle corresponding to the second candidate object orientation; and
searching for the object in the image rotated by the second angle to generate a second set of search results,
wherein the first and second confidence values are based on the first and second sets of search results, respectively.

5. The method of claim 1, further comprising:
adding a constant to the first confidence value such that the first candidate object orientation is preferred over the second candidate object orientation when estimating the orientation of the object.

6. The method of claim 1, further comprising:
analyzing the image using third and fourth candidate object orientations to generate respective third and fourth confidence values; and
estimating the orientation of the object based at least in part on the third and fourth confidence values,
wherein the third candidate object orientation differs from the first candidate object orientation by a second predetermined angle and the fourth candidate object orientation differs from the first candidate object orientation by a third predetermined angle.

7. The method of claim 6, wherein the second predetermined angle is approximately 90 degrees and the third predetermined angle is approximately 270 degrees.

8. The method of claim 6, further comprising:
adding a first constant to the first confidence value and a second constant, smaller than the first constant, to the second confidence value such that, when estimating the orientation of the object, the first candidate object orientation is preferred over the second candidate object orientation and the second candidate object orientation is preferred over the third and fourth candidate object orientations.

9. The method of claim 1, wherein the object is a face.

10. A computer-readable medium having computer-executable instructions adapted to carry out the method of claim 1.

11. A device for estimating an orientation of an object in an image, the device comprising:
an image detecting module adapted to detect the image; and
a processor adapted to:
estimate an orientation of the image;
analyze the image using first and second candidate object orientations to generate respective first and second confidence values; and
estimate the orientation of the object based at least in part on the first and second confidence values,
wherein the first candidate object orientation is equal to the estimated image orientation and the second candidate object orientation differs from the first candidate object orientation by a first predetermined angle.

12. The device of claim 11, wherein the first predetermined angle is approximately 180 degrees.

13. The device of claim 11, wherein the processor is further adapted to analyze an edge direction histogram of the image to estimate the orientation of the image.

14. The device of claim 11, wherein to generate respective first and second confidence values, the processor is further adapted to:
rotate the image with a first angle corresponding to the first candidate object orientation;
search for the object in the image rotated by the first angle to generate a first set of search results;
rotate the image by a second angle corresponding to the second candidate object orientation; and
search for the object in the image rotated by the second angle to generate a second set of search results,
wherein the first and second confidence values are based on the first and second sets of search results, respectively.

15. The device of claim 11, wherein the processor is further adapted to:
add a constant to the first confidence value such that the first candidate object orientation is preferred over the second candidate object orientation when the orientation of the object is estimated.

16. The device of claim 11, wherein the processor is further adapted to:
analyze the image using third and fourth candidate object orientations to generate respective third and fourth confidence values; and
estimate the orientation of the object based at least in part on the third and fourth confidence values,
wherein the third candidate object orientation differs from the first candidate object orientation by a second predetermined angle and the fourth candidate object orientation differs from the first candidate object orientation by a third predetermined angle.

17. The device of claim 16, wherein the second predetermined angle is approximately 90 degrees and the third predetermined angle is approximately 270 degrees.

18. The device of claim 16, wherein the processor is further adapted to:
add a first constant to the first confidence value and a second constant, smaller than the first constant, to the second confidence value such that, when the orientation of the object is estimated, the first candidate object orientation is preferred over the second candidate object orientation and the second candidate object orientation is preferred over the third and fourth candidate object orientations.

19. The device of claim 11, wherein the object is a face.
